(19) United States
(12) Patent Application Publication
(10) Pub. No.: US 2008/0103787 A1
(43) Pub. Date: May 1, 2008

(54) Methods, Mobile Terminals, Servers and Computer Program Products for Wirelessly Providing Real Property Information

(75) Inventors: Craig Cavanaugh, Atlanta, GA (US); Sadie Lowry, Atlanta, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/554,698

(22) Filed: Oct. 31, 2006

(51) Int. Cl. G06Q 10/00; G06Q 30/00

(52) U.S. Cl. 705/1

(57) ABSTRACT

A method of providing real property information can include receiving, at a real property information server, geographic location information from a mobile terminal indicating a position of the mobile terminal and selectively transmitting real property information associated with real property included in a real property listing database from the server to the mobile terminal based on proximity of the real property to the position of the mobile terminal.

### FIELD OF THE INVENTION

The present invention relates to electronic communications in general, and more particularly, to electronic communications for real estate.

### BACKGROUND

One of the ways in which real estate can be marketed is for a seller or broker to place a notice outside a property, where the notice lists information regarding the property. Some of the information listed on such notices can include price, square footage, number of bedrooms, etc. A potential buyer or broker can obtain the information by taking the notice from a distribution box located by the sidewalk in front of the property.

It is also known to provide information regarding real property in what is referred to as the Multiple Listing Service (“MLS”). In the MLS, information regarding properties can be listed in a database so that brokers (or buyers) can browse the database in search of property listings that may suit their customers or their own needs. The MLS may provide the same types of information described above in reference to the notices posted outside a property.

### SUMMARY

Embodiments according to the invention can provide methods, mobile terminals, servers and computer program products for wirelessly providing real property information. pursuant to these embodiments, a method of providing real property information can include receiving, at a real property information server, geographic location information from a mobile terminal indicating a position of the mobile terminal and selectively transmitting real property information associated with real property included in a real property listing database from the server to the mobile terminal based on proximity of the real property to the position of the mobile terminal.

In some embodiments according to the invention, a real property information server includes a processor circuit that is configured to receive geographic location information from a mobile terminal indicating a position of the mobile terminal and that is configured to selectively transmit real property information associated with real property to the mobile terminal based on proximity of the real property to the position of the mobile terminal. A real property listing database is coupled to the processor circuit and is configured to provide the processor circuit with access to the real property information.

In some embodiments according to the invention, a mobile terminal includes a mobile terminal transceiver circuit that is configured to transmit/receive signals, a geographic location determination circuit that is configured to determine geographic location information indicating a position of the mobile terminal, a screen that is configured to display real property information thereon and a processor circuit that is coupled to the mobile terminal transceiver circuit, to the geographic location determination circuit and to the screen. The processor circuit is configured to transmit the geographic location information from the mobile terminal to a real property information server via the mobile terminal transceiver circuit and is configured to receive the real property information from the server for display on the screen.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a schematic illustration of a wireless communications network coupled to a real property information server according to some embodiments of the invention.

FIG. 2 is a block diagram of a mobile terminal used to communicate with a real property information server in some embodiments according to the invention.

FIG. 3 is a block diagram of a real property information server in some embodiments according to the invention.

FIG. 4 is a schematic illustration of the relative locations of a mobile terminal and real properties for which real property information can be provided by a real property information server in some embodiments according to the invention.

FIG. 5 is a flowchart that illustrates operations of mobile terminals in communication with a real property information server in some embodiments according to the invention.

### DESCRIPTION OF EMBODIMENTS ACCORDING TO THE INVENTION

The present invention now is described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the“ are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense expressly so defined herein.

The present invention is described below with reference to diagrams (such as schematic illustrations) and/or operational illustrations of methods, devices, and computer program products according to embodiments of the invention. It is to be understood that the functions/acts noted in the figures may occur out of the order noted in the operational illustrations. For example, two elements shown in succession may in fact be executed substantially concurrently or the elements may sometimes be executed in the reverse order, depending upon the functionality/acts involved.

The present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

Computer program code or “code”for carrying out operations according to the present invention may be written in an object oriented programming language such as JAVA®, Smalltalk or C++, JavaScript, Visual Basic, TSQL, Perl, or in various other programming languages. Software embodiments of the present invention do not depend on implementation with a particular programming language. Portions of the code may execute entirely on one or more systems utilized by an intermediary server.

In some embodiments according to the invention, the computer program code may be provided to a processor circuit of a general purpose computer, special purpose computer, or other programmable data processing apparatus as instructions to produce a machine, such that the instructions, which execute via the processor circuit of the computer or other programmable data processing apparatus, create means for implementing the functions specified in the illustrations.

The computer code may be stored in a computer-readable memory that can direct a computer or other programmable data processing apparatus to function in a particular manner, such that the instructions stored in the computer-readable memory produce an article of manufacture including instruction means which implement the function specified in the illustrations.

The computer code may execute entirely on one or more servers, or it may execute partly on a server and partly on a client within a client device or as a proxy server at an intermediate point in a network. In the latter scenario, the client device may be connected to a server over a LAN or a WAN (e.g., an intranet), or the connection may be made through the Internet (e.g., via an Internet Service Provider). It is understood that the present invention is not TCP/IP-specific or Internet-specific. The present invention may be embodied using various protocols over various types of computer networks.

It will be understood that the invention may be practiced with any mobile terminal that operates in a communications network. A mobile terminal may be, for example, a cellular radiotelephone; a Personal Communications System (PCS) terminal that may combine a cellular radiotelephone with data processing, facsimile and data communications capabilities; a Personal Data Assistant (PDA) that can include a mobile terminal, pager, Internet/intranet access, Web browser, organizer, calendar and/or a global positioning system (GPS) receiver; and a conventional laptop and/or palmtop receiver or other mobile appliance.

It will be understood mobile terminals according to the invention may operate in any type of wireless communications network. In some embodiments according to the invention, for example, the network may provide services broadly labeled as PCS (Personal Communications Services) including advanced digital cellular systems conforming to standards such as IS-136 and IS-95, lower-power systems such as DECT (Digital Enhanced Cordless Telephone), data communications services such as CDPD (Cellular Digital Packet Data), and other systems such as CDMA-2000, that are proposed using a format commonly referred to as Wideband Code Division Multiple Access (WCDMA). In some embodiments according to the invention, the network can include an IP Multimedia Subsystem (IMS). IMS is a standardised Next Generation Networking (NGN) architecture for telecom operators to provide mobile and fixed multimedia services to mobile terminals. In some embodiments according to the invention, the network can provide services via WiMAX communications (World Interoperability for Microwave Access, Inc.), which is based on the IEEE 802.16 standard.

As described herein in greater detail, in some embodiments according to the invention, geographic location information that indicates a position of a mobile terminal can be forwarded to (and received at) at a real property information server as the mobile terminal moves relative to the positions of real properties. In response, real property information associated with real properties can be selectively transmitted from a real property listing database to the mobile terminal based on the proximity of the mobile terminal to the real properties.

For example, the real property information server can receive the geographic location of the mobile terminal and transmit real property information for several properties that are located near the mobile terminal, such as those in the neighborhood where the mobile terminal is currently located. In particular, proximity may be determined based on a proximity threshold which is compared to the distance separating the mobile terminal from the listings. If the distance separating the mobile terminal from a particular listing is less than the threshold, the server may transmit information associated with that listing to the mobile terminal. In contrast, if the mobile terminal is separated from the listing by more than the threshold, the real property information may not be transmitted to the mobile terminal.

Accordingly, a user of the mobile terminal may be provided with real property information associated with real property listings in the database as the user travels from one location to another and travels neared to the listed properties. In some embodiments according to the invention, the real property information associated with the real properties is provided in substantially real time. For example, the real property information associated with a particular listing may be provided to the mobile terminal as the mobile terminal location approaches the real property location.

In further embodiments according to the invention, the mobile terminal may be used to forward a request to show a property that is included in the real property listing database. For example, the mobile terminal can transmit the request to the server, which forwards the request to at least one recipient that is associated with the real property (such as the broker or seller). Accordingly, such contact information of the broker or seller may be included in the database. The recipient can forward a response to the mobile terminal indicating whether the property is available for showing.

In embodiments according to the invention, the real property database can store the real property information associated with real properties, such as a listing identifier, a listing location, image data or audio data related to the listing, showing profile information (such as availability information indicating whether a real property is available for showing, information indicating whether the real property is currently being shown and/or indicating specific times or days in which the listing may or may not be shown), advertising information indicating services that may be associated with the selling or buying of real estate (such as inspectors, brokers, etc.).

In some embodiments according to the invention, the real property information stored in the database can include property access information such as a location of a key, a location of a lockbox, and/or information indicating how to open a lockbox (such as a combination). In some embodiments according to the invention, the access information is provided in response to a password (also stored by the database) provided by the user at the mobile terminal and transmitted to the server.

In such embodiments according to the invention, the real property information server may receive a request for the access information that is associated with a real property included in the listing database. The server may then transmit a request for input of authorization to the mobile terminal. The user provides the requested input of authorization (e.g., the password) at the mobile terminal, which is transmitted to the server. If the input provided at the mobile terminal matches the authorization stored in the database, the access information is transmitted to the mobile terminal. If, however, the authorization does not match that stored in the database, access is denied.

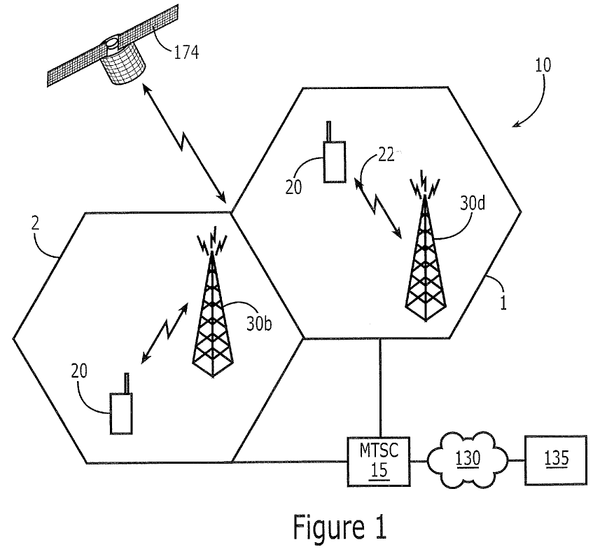

FIG. 1 is a diagram that illustrates a wireless communications network (network) 10 that supports communications in which mobile terminals 20 according to the invention can be used. Networks 10 are commonly employed to provide voice and data communications to subscribers using, for example, the standards discussed above. According to FIG. 1, the mobile terminals 20 can communicate with each other via a Mobile Telephone Switching Center (MTSC) 15. The mobile terminals 20 can also communicate with other terminals via a Public Service Telephone Network that is coupled to the network 10.

As also shown in FIG. 1, the MTSC 15 is coupled to a real property information server 135 via network 130, such as the Internet. The server 135 can provide real property information to the mobile terminals 20 as those terminals move within the network 10. In particular, the mobile terminals 20 can provide geographic location information (indicating respective positions of the mobile terminals) to the server 135, which can provide the real property information in response.

The network 10 is organized as cells 1-2 that collectively can provide service to a geographic region. In particular, each of the cells can provide service to associated sub-regions included in the geographic region covered by the network 10. More or fewer cells can be included in the network 10, and the coverage area for the cells may overlap. Each of the cells may include an associated base station 30a-b. The base stations 30a-b can provide wireless communications between each other and the mobile terminals 20 in the associated geographic region to allow for communications therebetween.

Each of the base stations 30a-b can transmit/receive data to/from the mobile terminals 20 over an associated control channel. For example, the base station 30a in cell 1 can communicate with the mobile terminal 20 over the control channel 22. The control channel 22 can be used, for example, to page the mobile terminal 20 in response to calls directed thereto or to transmit traffic channel assignments to the mobile terminal 20 over which a call associated therewith is to be conducted. The control channels 22 can be identified using control channel numbers or identifiers. For example, the mobile terminal 20 can store a channel number that identifies control channel 22 as the control channel on which it is currently camping.

The mobile terminals 20 may also be capable of receiving messages from the network 10 over the respective control channel 22. In some embodiments according to the invention, the mobile terminals receive Short Message Service (SMS) or Enhanced Message Service (EMS) formatted messages, Multimedia Message Service (MMS), and/or Smartmessaging™ formatted messages.

A Global Positioning System (GPS) 174 can provide GPS information to the geographic region including cells 1-2 so that the mobile terminals 20 may determine respective geographic location information. The geographic location information can then be forwarded to the server 135 for use in providing the real property information. As described herein in greater detail, the network 10 may also provide network location information as the basis for the geographic location information provided by the mobile terminals 20.

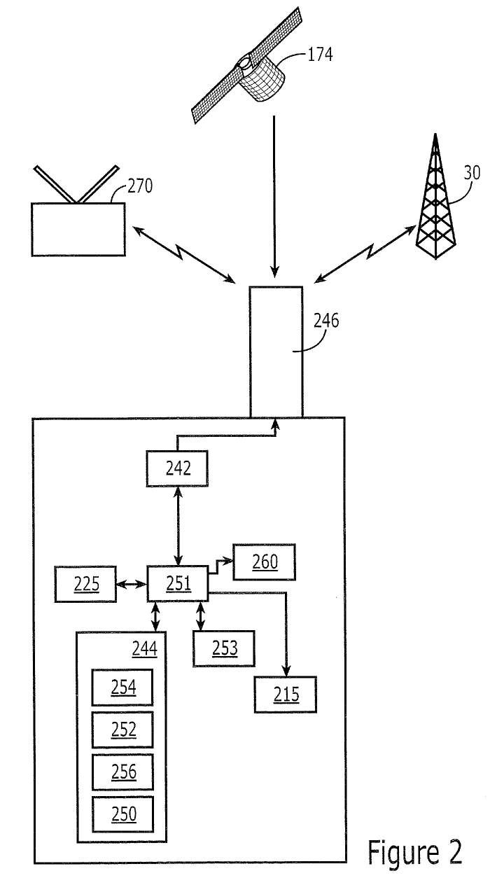

FIG. 2 is a block diagram that illustrates embodiments of mobile terminals 20 according to the invention. As illustrated in FIG. 2, the mobile terminal 20 includes a transceiver circuit 242 that is operative to transmit and receive radio frequency communication signals to the network 10 via an antenna system 246. The antenna system 246 may include an antenna feed structure and one or more antennas.

As is well known to those of skill in the art, a transmitter portion of the transceiver 242 converts information, which is to be transmitted by the mobile terminal 20, into electromagnetic signals suitable for radio communications. A receiver portion of the transceiver 242 demodulates electromagnetic signals, which are received by the mobile terminal 20 from the network 10 to provide the information contained in the signals in a format understandable to the user.

A user interface 244 of the mobile terminal 20 may include a variety of components, such as a display (or screen) 254, a keypad 252, a speaker 256, and a microphone 250, operations of which are known to those of skill in the art. It will be understood that the functions of the keypad 252 and the display 254 can be provided by a touch screen through which the user can view information, such as computer displayable documents, provide input thereto, and otherwise control the mobile terminal 20. It will be understood that computer displayable documents can be, for example, hypertext documents, which can include text, images, input fields, output fields, and a variety of other objects.

A processor circuit 251 provides for overall operation of the mobile terminal 20 including coordination of communications via the transceiver circuit 242, the user interface 244, and other components included in the mobile terminal 20. For example, the processor circuit 251 can provide communications signals to the transceiver circuit 242 when the user speaks into the microphone 250 and receives communications signals from the transceiver 242 for the reproduction of audio through the speaker 256. The processor circuit 251 can generate characters for display on the display 254. For example, the processor circuit 251 can generate numbers for display when the user enters a telephone number on the keypad 252. The characters can also be generated by a character generator circuit, which is not shown.

The processor circuit 251 may be implemented using a variety of hardware and software. For example, operations of the processor circuit 251 may be implemented using special-purpose hardware, such as an Application Specific Integrated Circuit (ASIC) and programmable logic devices such as gate arrays, and/or software or firmware running on a computing device such as a microprocessor, microcontroller or digital signal processor (DSP). The processor circuit 251 may provide digital signal processing operations such as scanning for an acceptable control channel, camping on a control channel.

The mobile terminal 20 includes a geographic location determination circuit 260 that is configured to determine the geographic location information for the mobile terminal. In some embodiments according to the invention, the location determination circuit 260 is a Global Positioning System (GPS) location circuit, including a GPS receiver circuit. The GPS location circuit may use any available GPS or assisted GPS based location approach in conjunction with the GPS satellite system 174. Such approaches are commonly referred to as assisted-GPS, which is defined, for example, in specification numbers 3GPP TS 04.31, 3GPP TS 03.71 and 3GPP TS 04.35. Assisted-GPS approaches are also discussed, for example, in U.S. Pat. Nos. 4,445,118, and 5,418,538, and 5,663,734, and 5,663,735, and 6,433,735, and in published US Patent Application No. US 2003/0011511 A1, the disclosures of which are hereby incorporated herein by reference.

In some alternative embodiments according to the invention, the geographic location determination circuit 260 is a network location circuit that uses location information provided by the network 10, such as one or more base station IDs, that has location information associated therewith. In some other embodiments according to the invention, the geographic location determination circuit 260 is a local area network location circuit that uses location information provided via a local wireless network 270 (through a local wireless interface circuit not shown) to determine the geographic location of the mobile terminal. In some embodiments according to the invention, the local area network is a WLAN compliant network. In some other embodiments according to the invention, the local wireless network 270 is a Bluetooth compliant interface. Other location determination approaches may be used. In any case, the local wireless network 270 can be used to provide information to the geographic location determination circuit 260 to determine the geographic location information that can be transmitted to the server 135 via the network 10.

In other embodiments according to the invention, the geographic location determination circuit 260 is a Radio Frequency Identification (RFID) based interface that can determine the geographic location information for the mobile terminal 20 by receiving a location code that is programmed into an RFID tag that identifies a particular property. In operation, as the mobile terminal 20 approaches the property the associated RFID tag would transmit a unique identifier for the property which the terminal may map to geographic information, which in-turn is transmitted to the server 135.

Radio Frequency Identification (RFIDs) refers to the use of low-cost “tags” embedded in or attached to items that can store “bar code” type information, as well as more detailed information about the items. The tags are generally small labels, or the like, with a miniature embedded antenna. A tag reader interrogates the tag by transmitting an RFID signal, which energizes the embedded antenna to provide power for the tag to transmit a responsive RFID signal to the reader. RFID tags are discussed further, for example, on the Internet at idtechex.com/pdfs/en/O7289Z3822.pdf, which is hereby incorporated herein by reference.

A memory 253 can store computer program instructions that, when executed by the processor circuit 251, carry out the operations described herein and shown in the figures. The memory 253 can be non-volatile memory, such as EEPROM (flash memory), that retains the stored data while power is removed from the memory 253. The memory can also store data used during operation, such the information to be displayed by the mobile terminal, the RFID mapped data, etc.

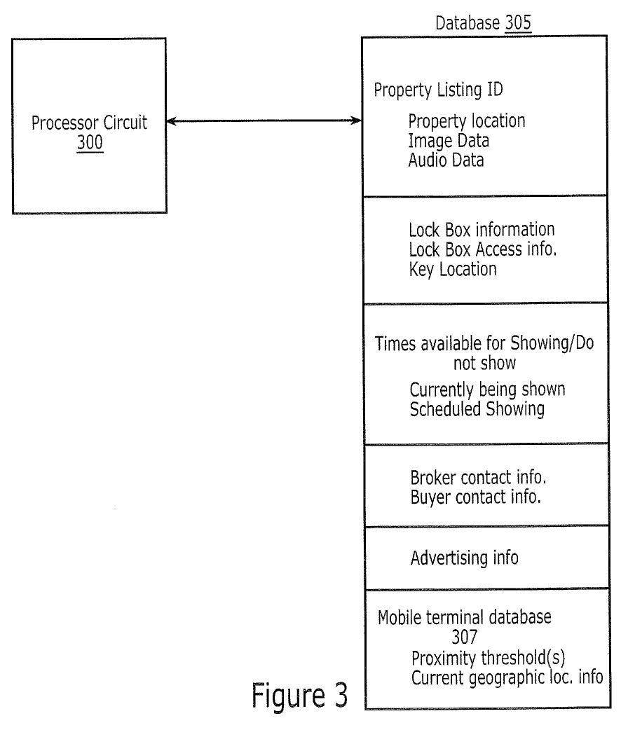

FIG. 3 is a block diagram that illustrates a real property information server 135 in some embodiments according to the invention. In particular, the real property information server 135 is configured to receive geographic location information indicating positions of mobile terminals while moving within the environment covered by the network 10 shown in FIG. 1. In response, the real property information server 135 selectively transmits real property information (that is associated with real property listings) to the mobile terminals 20 based on the proximity of the mobile terminals 20 to the real properties. The real property information server 135 is also configured to receive requests from the mobile terminals 20, such as requests to show a real property, and forward responses to those requests to the mobile terminals.

Referring to FIG. 3, the real property information server 135 includes a processor circuit 300 that is configured to receive the geographic location information from the mobile terminals and process requests therefrom. The process circuit 300 is further configured to forward the real property information associated with the real property listings to the mobile terminals 20.

The server 135 also includes a real property listing database 305 that can be accessed by the processor circuit 300. The real property listing database 305 can include the real property information that is associated with real property listings. The real property listings can be accessed via, for example, a Multiple Listing Service (“MLS”) 315 to which the server 135 is operatively coupled over, for example, the Internet. For example, the database 305 may incorporate standard real property listing information from the MLS 315, such as address information, price, physical parameters related to the property such as numbers of bedrooms, etc. Although the database 305 is shown in FIG. 3 as part of the server 135, the database 305 may be remote from the server 135, but configured for access by the processor circuit 300 over a network.

The database 305 can include information to assist in processing the geographic location information from the mobile terminal to selectively transmit the real property information to the mobile terminals. In particular, the database 305 can include a property listing identifier which uniquely identifies the real property with which other information store in the database 305 is associated. In particular, a complete set of data for each property listing in the database can be accessed (or indexed) using the property listing identifier. For example, the geographic location for a property stored in the database 305 may be accessed using the property listing identifier so that the processor can compare to the geographic location of the property to the location information provided by the mobile terminal.

In operation, the processor circuit 300 can determine the proximity of the mobile terminal to the listings within the database 305 based on the geographic location information for the properties stored within the database. For example, the processor circuit may determine that the mobile terminal is relatively close to a first property listing by comparing the first property's geographic location information (stored in the database 305) to the geographic location information provided by the mobile terminal. The processor circuit 300 may then transmit real property information for listings that are located proximate to the mobile 20. The listing may also have associated with it audio and/or image data which can be transmitted to the mobile terminal 20 to help the user more easily identify the property upon approach.

Additional information that can be associated with a listing in the database 305 is generally referred to as property access information and it can include lockbox location indicating location of a lockbox at the real property which the broker may use to access the property. The property access information can also include key location information indicating where a key to the property can be found (such as in cases where a key is hidden at the property rather than left in a lockbox). The property access information can further include lockbox access information indicating an authorization code which is needed before lockbox information or other secure information is transmitted to the mobile terminal. For example, the lockbox access information can be a password which is received from the mobile terminal prior to the lockbox location information or key location information is transmitted to the mobile terminal. The real property information stored for each of the listings in the database 305 can also include showing profile information. The showing profile information can include times for which the property listing may be shown or now shown, an indication as to whether the property listing is currently being shown, times at which future showings are scheduled, and the like.

Each of the property listings in the database 305 can also include contact information which may be provided to the mobile terminal as part of the real property information or may be used when forwarding messages or requested from the mobile terminals 20. The database 305 can also include advertising information as part of the real property information forwarded to the mobile terminals, In particular, the advertising information can include information regarding inspectors, other brokers, engineers or other services or products related to buying or selling of real property.

The database 305 can also include (or reference) a database 307 for the mobile terminals 20 operating within the network 10. For example, the database 305 may include entries for each of the mobile terminals 20 currently registered in the network 10, which can include the respective current geographic location information for the mobile terminal 20 and a proximity threshold which can be used by the processor circuit 300 to determine whether real property information associated with a listing is to be transmitted to the mobile terminal 20.

The database 305 can also include demographic information describing a profile of for the property location or area. For example, the demographic information may include information indicating the average age of residents or home owners in the area, the average number of children, single adults, married couples, retired persons, or the like.

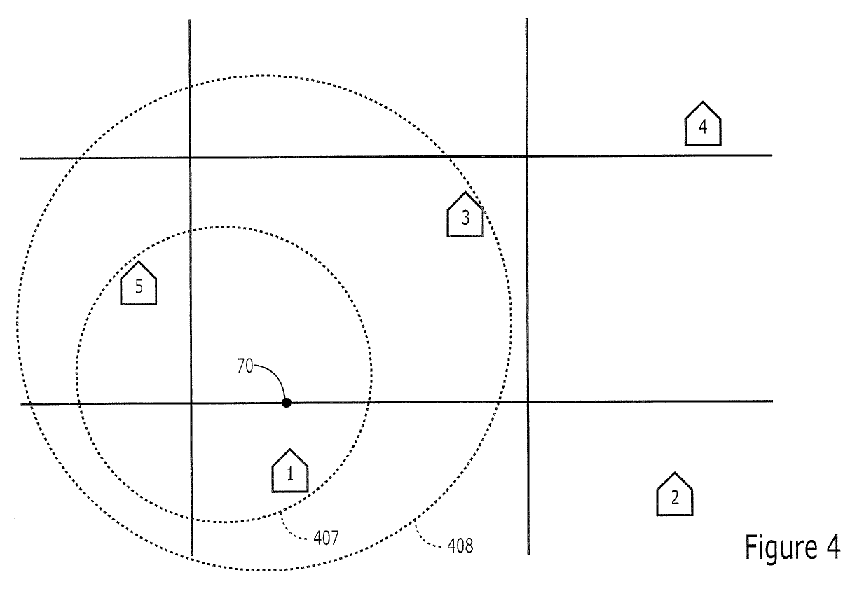

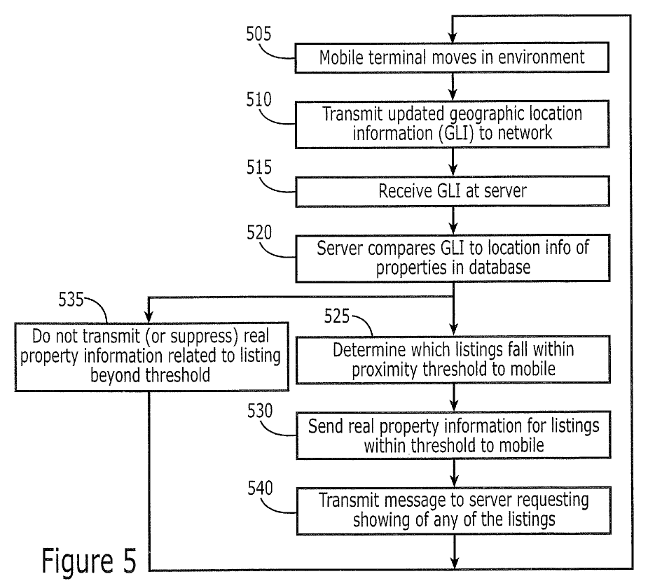

FIG. 4 is a schematic illustration of the mobile terminal 20 moving within an environment 400 including intersecting lines representing streets where real properties 1-5 are located at different positions in some embodiments according to the invention. FIG. 5 is a flowchart that illustrates operations of mobile terminals in communication with a real property information server in some embodiments according to the invention, which is described herein with reference to FIG. 4.

Referring to FIGS. 4 and 5, the mobile terminal 20 is in communication with the network 10 to provide geographic location information to the server 135. As the mobile terminal 20 moves within the environment 400 (block 505), updated geographic location information is transmitted to the server 135 changes in real time or near real time (block 510).

As further shown in FIG. 4, the mobile terminal 20 is separated from the real property listings 1-5 by respective distances. The server 135 receives the geographic location information from the mobile terminal 20 (block 515) and compares that location to the geographic location information for the listings in the database 305 (block 5200. The processor circuit 300 can refer to the proximity threshold associated with the mobile terminal 20 to further determine which listings stored in the database 305 will be selected for the transmission of real property information to the mobile terminal 20 (block 525).

In particular, the real property listings determined to fall within the proximity threshold for the mobile terminal 20 will qualify for the transmission of real property information associated therewith to the mobile terminal 20 (block 530). For example, region 407 shown in FIG. 4 represents a first proximity threshold for the mobile terminal 20 based on the terminal's current geographic location. As further shown in FIG. 4, real estate listings 1 and 5 stored in the database 305 have geographic locations that place these listings within the first proximity threshold for the mobile terminal 20. Accordingly, the server 135 can transmit real estate information for listings 1 and 5 to the mobile terminal 20 for display.

In contrast to the above, the real property information associated with listings 2, 3 and 4, may not be transmitted by the server 135 to the mobile terminal 20 as these listings fall outside the first proximity threshold 407 (block 535). In other embodiments according to the invention, the real property information associated with listings 2, 3 and 4 may be transmitted by the mobile terminal 20 despite being outside the first proximity threshold 407 but the display of the real property information associated with those listings outside the first proximity threshold 407 can be suppressed by the mobile terminal 20.

As further shown in FIG. 4, the proximity threshold for the mobile terminal 20 may be increased to provide a second proximity threshold 408. When the server 135 receives the geographic location information for the mobile terminal 20 the second proximity threshold 408 indicates that the real property information for listing 3 should also forwarded by the server 135 to the mobile terminal 20 (or alternatively is no longer suppressed by the mobile terminal 20 and is therefore displayed). It will be understood that although only two proximity thresholds are shown in FIG. 4, more proximity thresholds may be supported by the database.

Referring further to FIG. 4, a user of the mobile terminal 20 may request a showing of any of the listings by transmitting a message to the server 135, which may, in turn, be forwarded to a recipient using the contact information stored in the database 305 described above (block 540). For example, as a broker drives through the environment shown in FIG. 4, the real estate information associated with the listing 3 may appear on the screen of the mobile terminal 20 or whereupon the user may transmit a request to schedule a showing of property listing 3. The message is transmitted to the server 135, which is forwarded to a recipient specified by the contact information for listing number 3 in the database 305.

It will be understood that the message transmitted from the mobile terminal 20 to the server 135 and from the server 135 to the recipient can be in any electronic form, such as, an SMS formatted message, an MMS formatted message, an e-mail formatted message, and/or an SMS formatted message. Other types of messages can be used.

When the recipient of the request for the showing transmits a response (either via the server 135 or via the network 10 directly) the server 135 can be updated to reflect the scheduled showing of the listing at a particular time by updating the relevant showing profile information. If the response is forwarded to the server 135, the message to the mobile terminal 20 can include additional information from the database 305 such as the property information, property access information, as well as advertising associated with the listing in the database 305. In still other embodiments according to the invention, the response to the request for showing may indicate that the property is not currently available for showing and, further, may offer an alternative time for showing. Any of these responses can illicit further requests from the mobile terminal 20, such as a confirmation of a proposed alternative showing time/date.

In still other embodiments according to the invention, the address for the property listing transmitted to the mobile terminal 20 may be suppressed. For example, when the mobile terminal 20 moves so that a particular listing is within the proximity threshold, selected real estate information can be transmitted to the mobile terminal 20 for display. In some embodiments according to the invention, the address of the listing transmitted to the mobile terminal 20 may not be specified and may, instead, request that the viewer contact (via, for example, a message) a specified broker for further information and/or to request access to the property, the address of which may be revealed later. Accordingly, a prospective customer may be interested in a certain neighborhood regardless of whether property address is known. Furthermore, the address of the property may be unspecified as the property may not be officially listed in the database 305 (or the MLS) at the time at which the real estate information is transmitted to the mobile terminal 20.

In still other embodiments according to the invention, multiple proximity thresholds may be used to specify the amount or type of real estate information that is to be transmitted to the mobile terminal 20. For example, according to FIG. 4, more detailed information may be sent regarding listings 1 and 5 that fall within the first proximity threshold 407, whereas less information is transmitted for listings that are more remote from the mobile terminal geographic location but still within the second proximity threshold 408. Accordingly, numerous indications of property listings in the general area may be indicated on the mobile terminal screen but more detailed information regarding the closest listings may be highlighted.

Moreover, as the mobile terminal 20 moves within the environment, closer to the listings which are more remote (thereby making the more remote listings become proximate and the formerly proximate listings become more remote), the information transmitted to the mobile terminal 20 changes so that the newly proximate listings become more prominent and/or have more detailed information associated therewith displayed. In still other embodiments according to the invention, more recent listings may be further emphasized on display such as using a particular color or some other indicia which highlights the presence of the listing relative to the other listings displayed.

As described above, in some embodiments according to the invention, geographic location information that indicates a position of a mobile terminal can be forwarded to (and received at) at a real property information server as the mobile terminal moves relative to the positions of real properties. In response, real property information associated with real properties can be selectively transmitted from a real property listing database to the mobile terminal based on the proximity of the mobile terminal to the real properties.

For example, the real property information server can receive the geographic location of the mobile terminal and transmit real property information for several properties that are located near the mobile terminal, such as those in the neighborhood where the mobile terminal is currently located. In particular, proximity may be determined based on a proximity threshold which is compared to the distance separating the mobile terminal from the listings. If the distance separating the mobile terminal from a particular listing is less than the threshold, the server may transmit information associated with that listing to the mobile terminal. In contrast, if the mobile terminal is separated from the listing by more than the threshold, the real property information may not be transmitted to the mobile terminal.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed:

1. A method of providing real property information comprising:
receiving, at a real property information server, geographic location information from a mobile terminal indicating a position of the mobile terminal; and
selectively transmitting real property information associated with real property included in a real property listing database from the server to the mobile terminal based on proximity of the real property to the position of the mobile terminal.

2. A method according to claim 1 wherein selectively transmitting further comprises:
determining distances separating the mobile terminal from real properties included in the real property listing database; and
comparing the distances to a proximity threshold to select which real property information is to be transmitted to the mobile terminal.

3. A method according to claim 1 wherein receiving geographic location information from a mobile terminal indicating a position of the mobile terminal comprises receiving the geographic location information from the mobile terminal in real-time as the mobile terminal moves relative to the real property included in the real property listing database.

4. A method according to claim 1 further comprising:
receiving a request to show a real property included in the real property listing database;
forwarding the request to at least one recipient associated with the real property;
receiving a response to the request from the at least one recipient; and
forwarding the response to the mobile terminal.

5. A method according to claim 1 wherein the real property information associated with real property comprises MLS information.

6. A method according to claim 1 wherein the real property information associated with real property comprises showing availability information indicating whether a real property is available for showing.

7. A method according to claim 6 wherein the showing availability information indicates that the real property is currently being shown.

8. A method according to claim 1 wherein the real property information associated with real property comprises showing profile information, image data, audio data, advertising information, demographic information, and/or access information.

9. A method according to claim 8 wherein the access information comprises a location of a key, location of a lock box, and/or authorization for the lock box.

10. A method according to claim 1 further comprising:
receiving, at the real property information server, a request for access information associated with a real property included in a real property listing database;
transmitting, to the mobile terminal, a request for input of authorization to transmit the access information;
receiving, at the real property information server, the authorization from the mobile terminal responsive to the request; and
transmitting, to the mobile terminal, the access information if the authorization received from the mobile matches an authentic authorization associated with the real property to which the request for access information was directed.

11. A method according to claim 2 further comprising a plurality of proximity thresholds associated with the real property in the database.

12. A method according to claim 1 wherein the real property listing database comprises Global Positioning Satellite system location information.

13. A method according to claim 1 embodied in a computer program product comprising a computer readable medium having computer readable program code embodied therein.

14. A real property information server comprising:
a processor circuit configured to receive geographic location information from a mobile terminal indicating a position of the mobile terminal and configured to selectively transmit real property information associated with real property to the mobile terminal based on proximity of the real property to the position of the mobile terminal; and
a real property listing database, coupled to the processor circuit, configured to provide the processor circuit with access to the real property information.

15. A real property information server according to claim 14 wherein the real property listing database is configured to store:
availability information indicating whether a real property is available for showing and/or whether the real property is currently being shown; and
profile information, image data, audio data, advertising information, and/or access information including a key, location of a lock box, and/or authorization for the lock box.

16. A real property information server according to claim 14 wherein the processor circuit is further configured to receive a request to show a real property included in the real property listing database and configured to forward the request to at least one recipient associated with the real property and configured to receive a response to the request from the at least one recipient and is configured to forward the response to the mobile terminal.

17. A mobile terminal comprising:
a mobile terminal transceiver circuit configured to transmit/receive signals;
a geographic location determination circuit configured to determine geographic location information indicating a position of the mobile terminal;
a screen configured to display real property information thereon; and
a processor circuit, coupled to the mobile terminal transceiver circuit, the geographic location determination circuit and to the screen, the processor circuit configured to transmit the geographic location information from the mobile terminal to a real property information server via the mobile terminal transceiver circuit and configured to receive the real property information from the server for display on the screen.

18. A mobile terminal according to claim 17 wherein the real property information comprises:
availability information indicating whether a real property is available for showing and/or whether the real property is currently being shown; and
profile information, image data, audio data, advertising information, and/or access information including a key, location of a lock box, and/or authorization for the lock box.

19. A mobile terminal according to claim 17 wherein the processor circuit is configured to specify a proximity threshold associated with the geographic location information.

20. A mobile terminal according to claim 19 wherein the proximity threshold indicates a distance from the position of the mobile terminal beyond which the display of real property information associated with corresponding real property listings is suppressed.
